(19) United States
(12) Patent Application Publication
(10) Pub. No.: US 2016/0019549 A1
(43) Pub. Date: Jan. 21, 2016

(54) ZEIT TRACKER RESPONSE AND TIME MANAGEMENT TOOL

(71) Applicant: Bank of America Corporation, Charlotte, NC (US)

(72) Inventors: Syed Maizuddin, Hyderabad (IN); Sudhir Kumar Biswal, Hyderabad (IN)

(21) Appl. No.: 14/336,204

(22) Filed: Jul. 21, 2014

(51) Int. Cl. G06Q 30/00; H04L 12/26; G06Q 10/06; H04L 12/58

(52) U.S. Cl. CPC G06Q 30/016; H04L 51/043; H04L 43/106; G06Q 10/06398

(57) ABSTRACT

The present invention includes a software-based tool for tracking associate response time in regards to responding to customer inquiries via a chat conversation. The response time tracking tool is configured to alert the associate of how much time has elapsed since receiving a customer response (e.g., an inquiry, a question, a chat message, or the like). The response time tracking tool includes both clock and timer functions and is configured to not only buzz at predetermined intervals, but also change colors at predetermined intervals. Buzzing and changing the color of the response time tracking tool not only helps the associate maintain an appropriate response time to customer responses when assisting multiple customers simultaneously, but also helps eliminate dead air and delays while interacting with the customer. Therefore, the response time tracking tool is particularly useful for enabling the associate to deliver an excellent customer service experience.

### BACKGROUND

There is a need for an associate response time tracking tool that enables an associate to monitor his or her response time in regards to responding to chat conversations with customers.

### BRIEF SUMMARY

The present invention further includes a software-based tool for tracking associate response time in regards to responding to customer inquiries via a chat conversation. The response time tracking tool is configured to alert the associate of how much time has elapsed since receiving a customer response (e.g., an inquiry, a question, a chat message, or the like). The response time tracking tool includes both clock and timer functions and is configured to not only buzz at predetermined intervals, but also change colors at predetermined intervals. Buzzing and changing the color of the response time tracking tool not only helps the associate maintain an appropriate response time to customer responses when assisting multiple customers simultaneously, but also helps eliminate dead air and delays while interacting with the customer. Therefore, the response time tracking tool is particularly useful for enabling the associate to provide an excellent customer service experience.

In some embodiments, a system for tracking associate response time in a chat conversation between an associate and a customer is provided. The apparatus comprises: a memory; a processor; and a module stored in memory, executable by a processor, and configured to: receive a first line of the chat conversation submitted by the customer at a first timestamp; receive a second line of the chat conversation submitted by the associate at a second timestamp; determine an associate response time based on a calculated time difference between the second timestamp and the first timestamp; and associate the calculated associate response time with the received second line of the chat conversation.

In some embodiments, receiving the first line of the chat conversation initiates counting of a timer substantially simultaneous to the first timestamp.

In some embodiments, the timer comprises a suite of functions that enables the associate to at least one of start, stop, pause, reset, or exit the timer.

In some embodiments, the timer comprises a clock function.

In some embodiments, the clock function is configured to sync with a system clock associated with a device associated with the associate and used to run a customer chat conversation application.

In some embodiments, the customer chat conversation application enables the associate to hold at least one and up to three simultaneous customer chat conversations with customers.

In some embodiments, the timer is configured to be displayed via an interface in a window.

In some embodiments, the window associated with the timer includes a background color, wherein the background color is configured to change at predetermined time intervals.

In some embodiments, the timer is configured to activate an audible buzzer at predetermined time intervals.

In some embodiments, the buzzer comprises mute and unmute functions.

In some embodiments, the window associated with the timer is positioned on top of all other open windows so that the window associated with the timer is always visible by the associate via the interface, wherein the window associated with the timer is configured to be moved on the interface independent of all other open applications.

In some embodiments, receiving the second line of the chat conversation initiates stoppage of counting by the timer substantially simultaneously to the second time stamp.

In some embodiments, determining the associate response time comprises: comparing the associate response time to a predetermined time limit; determining that the associate response time is equal to or exceeds the predetermined time limit.

In some embodiments, determining the associate response time comprises calculating an average associate response time for at least one of the chat conversation held between the associate and the customer as a whole or all chat conversations held between the associate and a plurality of customers.

In some embodiments, determining the associate response time comprises calculating a total amount of time associated with how long the associate has been logged in to the customer chat conversation application.

In some embodiments, the timer is configured to reset substantially simultaneously to the second time stamp.

In some embodiments, associating the calculated associate response time with the received second line of the chat conversation comprises associating the calculated average response time with the associate.

In some embodiments, associating the calculated associate response time with the received second line of the chat conversation comprises generating a report that includes at least the calculated associate response time and transmitting the report to at least one of the associate, an administrator, a team manager, a team leader, a supervisor, or a customer service specialist.

In some embodiments, a method for tracking associate response time in a chat conversation between an associate and a customer is provided. The method comprises: receiving, using a computing device processor, a first line of the chat conversation submitted by the customer at a first timestamp; receiving, using a computing device processor, a second line of the chat conversation submitted by the associate at a second timestamp; determining, using a computing device processor, an associate response time based on a calculated time difference between the second timestamp and the first timestamp; and associating, using a computing device processor, the calculated associate response time with the received second line of the chat conversation.

In some embodiments, a computer program product for tracking associate response time in a chat conversation between an associate and a customer. The computer program product comprises a non-transitory computer-readable medium comprising code causing an apparatus to: receive a first line of the chat conversation submitted by the customer at a first timestamp; receive a second line of the chat conversation submitted by the associate at a second timestamp; determine an associate response time based on a calculated time difference between the second timestamp and the first timestamp; and associate the calculated associate response time with the received second line of the chat conversation.

The response time tracking tool of the present invention provides many benefits. First, the response time tracking tool enables an associate to closely monitor her or his response time delays in regards to responding to chat conversations with one or more customers. The clock and timer functions increase associate awareness of the two-minute and five-minute response time limits. Furthermore, a buzzing function and a background color changing function provide both visual and auditory alerts to the associate of urgency in regards to responding to chat conversations with one or more customers. All in all, the response time tracking too is focused on improving delivery of a high-quality customer service experience.

### BRIEF DESCRIPTION OF THE DRAWINGS

Having thus described embodiments of the invention in general terms, reference will now be made to the accompanying drawings, where:

FIG. 1 is an exemplary user interface for a customer chat conversation application used by the associate, in accordance with embodiments of the present invention;

FIG. 2 is an exemplary user interface for a chat analyzer tool, in accordance with embodiments of the present invention;

FIG. 3 is an exemplary user interface for a feedback form, in accordance with embodiments of the present invention;

FIG. 4 is an exemplary system-generated message based on an analysis of a chat conversation transcript, in accordance with embodiments of the present invention;

FIG. 5 is an exemplary interface for a response time tracking tool window, in accordance with embodiments of the present invention;

FIG. 6 is an exemplary functional flow map for a response time tracking tool window, in accordance with embodiments of the present invention;

FIG. 7 is an exemplary process flow illustrating a process for analyzing a chat conversation between an associate and a customer, in accordance with embodiments of the present invention;

FIG. 8 is an exemplary process flow illustrating a process for tracking associate response time in a chat conversation between an associate and a customer, in accordance with embodiments of the present invention; and

FIG. 9 is an exemplary system environment for executing functions associated with a chat analyzer system and a response time tracking tool, in accordance with embodiments of the present invention.

### DETAILED DESCRIPTION OF THE PRESENT INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In other embodiments, an “entity” may not be a financial institution.

The present invention is directed to a software-based system for providing instantaneous and productive feedback to an associate (an agent, a customer service specialist, a teller, a virtual assistant, an online banking chat person, or the like) on a recent chat conversation with a customer (e.g., an account holder, an investor, a potential customer, or the like). A user (e.g., a supervisor, an administrator, a customer service manager, or the like) utilizes the system of the present invention to analyze a chat conversation transcript between the associate and the customer. Analysis of the chat conversation transcript includes a variety of processing features such as detecting of dead air or delays in the chat conversation, spell checking, detecting non-listed or unapproved phrases used by the associate in the chat conversation, and instantaneous documenting of feedback based on the analysis of the chat conversation transcript.

The system of the present invention receives a transcript of a recent chat conversation between the associate and the customer. In a preferred embodiment, the user provides the chat conversation transcript to the system via copy and paste functions. In other embodiments, the system is configured to retrieve the chat conversation transcript from a memory location or from a second apparatus (e.g., a device associated with the associate or the user, or the like). Alternatively, the chat conversation transcript may be generated by the user before being transmitted to and received by the system, or the system may be configured to generate the chat conversation transcript upon receipt. The chat conversation transcript may include multiple chat conversation transcripts between multiple users and the associate. Typically, the associate is responsible for handling between one and three simultaneous chat conversations, so the system may receive one to three chat conversation transcripts (or another number of chat conversation transcripts dependent on the number of handled chat conversations).

Upon receipt of the chat conversation transcript, the system is configured to generate a transcript identification (ID) and associate the generated transcript ID with the chat conversation transcript for reference and access control. For example, only a predetermined list of users (e.g., the associate and the associate's supervisor) may have access to the chat conversation transcript associated with a transcript ID. However, in a preferred embodiment, the system is not configured to save any part of the chat conversation transcript (except for the transcript ID associated with the chat conversation transcript) for data security and confidentiality purposes.

The system inputs the received chat conversation transcript into a workbook (e.g., a spreadsheet) associated with the system upon receipt of the chat conversation transcript. Multiple received chat conversation transcripts are each inputted into separate workbook sheets. Each line of the chat conversation typically is inputted into one row of the workbook. Once the chat conversation transcript is inputted into the workbook, the chat conversation transcript is ready for analysis.

The user then provides a commencement input to the system that signals to the system that the user wishes to begin the analysis process. In a preferred embodiment, the user presses an “A” (Analyzer) button on a screen, keyboard, touchscreen, touchpad, or other input device. In other embodiments, the use may click, make a selection, or provide another input or input type. The commencement input is received by the system and the system begins analyzing the chat conversation transcript in a line-by-line fashion. The chat conversation transcript may be analyzed substantially simultaneously to receiving the chat conversation transcript, or at a predetermined period of time after receiving the chat conversation transcript.

Analyzing the chat conversation transcript includes detecting dead air or delays in response time throughout the chat conversation. The system is configured to determine a timestamp for each line of the chat conversation (e.g., a time at which each line of chat conversation was submitted to the chat conversation). The system then calculates a response time for each line of the chat conversation in the chat conversation transcript, which is typically equal to the difference in time between the timestamps of adjacent lines of the chat conversation. For example, the system determines that it took the associate thirty-two seconds to respond to a question posed by the customer because the associate's response to the customer's question was received in the chat conversation thirty-two second after the customer's question was received in the chat conversation. In this regard, the system enables the user to monitor how long it took the associate to respond to the customer.

The calculated response time for each line of the chat conversation in the chat conversation transcript is then compared to a predetermined threshold value associated with a maximum allowable amount of time allowed between a line of the chat conversation provided by the customer and the associate's response. Typically, the maximum allowable amount of time between a line of the chat conversation provided by the customer and the associate's response (e.g., the predetermined amount of time) is two minutes. For example, a response time determined to be greater than two minutes is determined to be an Opportunity and may be classified as a delay or dead air. If the response time of a line of the chat conversation associated with the associate is determined to be greater than the predetermined threshold value the system may flag or make note of that particular line of the chat conversation so that the exceeded response time is easily noticeable by the user during review of the chat conversation transcript (e.g., changing the calculated response time's font size, style, color, highlights, or the like).

Additionally, the system may also compare the calculated response time for each line of the chat conversation in the chat conversation transcript to a second predetermined threshold value associated with an amount of time. The second predetermined threshold value may be a larger maximum allowable amount of time allowed between a line of the chat conversation provided by the customer and the associate's response. For example, a response time greater than five minutes is determined to be a Critical Service Failure (CSF). If the response time of a line of the chat conversation associated with the associate is determined to be greater than the second predetermined threshold value the system may flag or make note of that particular line of the chat conversation so that the exceeded response time is easily noticeable by the user during review of the chat conversation transcript (e.g., changing the calculated response time's font size, style, color, highlights, or the like).

The system may also analyze a chat conversation transcript in real time (e.g., while the associate is providing service to the customer). The system may include means for generating and/or sending a predetermined line of conversation (e.g., a canned message, an alert, or the like) to the chat conversation on behalf of the associate before the response time reaches or exceeds the predetermined (or second predetermined) threshold value (e.g., two minutes or five minutes after receiving a line of conversation from the customer). By sending an automatic message on behalf of the associate within the predetermined threshold value, the system helps eliminate the possibility of the response time exceeding the predetermined threshold value and therefore ensures a high level of customer service is being consistently delivered to the customer.

Analyzing the chat conversation transcript further includes determining any spelling or grammatical errors in the lines of conversation in the conversation transcript provided by the associate. The system compares a combination of text characters (e.g., words, phrases, and sentences) in each line of the chat conversation in the chat conversation transcript to a database of words, acronyms, grammatical rules, or the like known and/or used by the entity. Alternatively, the system may be integrated with a third-party or proprietary dictionary, existing spell-check software, or the like that is configured to analyze the chat conversation transcript in real time and then transmit the analyzed chat conversation transcript to the system after its analysis is complete. Based on the comparison, the system determines or identifies any spelling or grammatical errors in the lines of conversation in the conversation transcript provided by the associate. In response, the system may flag or make note of any errors in a particular line of the chat conversation so that the errors are easily noticeable by the user during review of the chat conversation transcript (e.g., changing a word's font size, style, color, highlights, or the like).

The system may include or have access to a database that includes a plurality of canned responses (e.g., predetermined pre-typed, pre-approved, pre-listed responses to a variety of customer requests, questions, statements, responses, or the like). These canned responses may be selected via a menu, a database, typing a shortcut, or the like to be used by the associate during the chat conversation in response to the customer. Use of canned responses is typically encouraged by the entity because using canned responses ensures that the associate's responses to the customer contain no spelling or grammatical mistakes.

Analyzing the chat conversation transcript further includes determining which lines of conversation in the conversation transcript provided by the associate are canned responses. The system is configured to compare a combination of text characters (e.g., words, phrases, and sentences) in each line of the chat conversation in the chat conversation transcript to the database of canned responses known and/or used by the entity. Alternatively, the system may be integrated with a third-party or proprietary dictionary, existing spell-check software, or the like that is configured to analyze the chat conversation transcript in real time and then transmit the analyzed chat conversation transcript to the system after its analysis is complete. Based on the comparison, the system determines or identifies any spelling or grammatical errors in the lines of conversation in the conversation transcript provided by the associate. In response, the system may flag or make note of any errors in a particular line of the chat conversation so that the errors are easily noticeable by the user during review of the chat conversation transcript (e.g., changing a word's font size, style, color, highlights, or the like). Typically, identified canned responses in the conversation transcript are highlighted in gray.

Analyzing the chat conversation transcript further includes calculating various metrics based on the analysis of the chat conversation transcript. Examples of calculated metrics include a total number of spelling or grammatical errors determined to be in the chat conversation transcript provided by the associate, a total chat conversation length or duration, a total number of canned responses determined to be in the chat conversation transcript provided by the associate, a total number of non-canned responses determined to be in the chat conversation transcript provided by the associate, a total number of times that the response time limit is exceeded in the chat conversation transcript, or the like.

After analysis of the chat conversation transcript is complete, the system is configured to enable the user to provide feedback to the associate in regards to the chat conversation based on the analysis of the chat conversation transcript. The system presents to the user a feedback form via an interface. The feedback form includes various input fields (e.g., selection menus, text fields, or the like) that enable the user to input information associated with the chat conversation transcript, as well as the associate's performance in the chat conversation. The user inputs information associated with the chat conversation transcript as well as the associate's performance in the chat conversation via an input device or the interface. The system may also prepopulate some pieces of information into the feedback form based on the analysis of the chat conversation transcript. Once inputted, the information is transmitted to and received by the system. The user may be enabled to override any identified errors by selecting an “O” button on the interface. In this regard, the user is enabled to customize documentation of feedback and analysis.

The system receives the inputted information associated with the chat conversation transcript as well as the associate's performance in the chat conversation. The system is configured to then generate a message (e.g., an email, a notification, an alert, a text message, or the like) based on the information associated with the chat conversation transcript as well as the associate's performance in the chat conversation. The message may be generated automatically by the system or in response to the user selecting an “F” button on an interface which signals to the system that documentation of feedback and analysis is to be created in substantially real time.

The generated message is generated in accordance with an existing template. Generating the message in accordance with an existing template ensures that documentation across all chat conversation transcript analyses is uniform, easy to read and understand, and that documentation errors are minimized. The message may include pre-approved or pre-formed comments, sentences, phrases, words, or the like that clearly communicate the results of the analysis of the chat conversation transcript and the performance review of the associate provided by the user. Typically, the generated message is generated by the system substantially simultaneously to receiving the inputted information associated with the chat conversation transcript as well as the associate's performance in the chat conversation from the user. The generated message also may include suggestions for improving associate performance.

The system is further configured to transmit the generated message to the associate for review. Typically, the generated message is transmitted to the associate substantially simultaneously to generating the message. Alternatively, the generated message may be transmitted to the user, the customer, or another person at a predetermined time after generating the generated message.

The system is configured to erase any information inputted by the user or associated with the chat conversation or the chat conversation transcript for data security and customer confidentiality purposes. In alternative embodiments, the system may store some information, the chat conversation transcript, or the like for future recall or reference.

The present invention further includes a software-based tool for tracking associate response time. The response time tracking tool is configured to alert the associate of how much time has elapsed since receiving a customer response. The response time tracking tool includes both clock and timer functions and is configured to not only buzz at predetermined intervals, but also change colors at predetermined intervals. Buzzing and changing the color of the response time tracking tool not only helps the associate maintain an appropriate response time to customer responses when assisting multiple customers simultaneously, but also helps eliminate dead air and delays while interacting with the customer. Therefore, the response time tracking tool is particularly useful for enabling the associate to provide an excellent customer service experience.

Typically, and as stated above, the associate is required to manage up to three conversations with three different customers in regards to three potentially different customer requests. As expected, holding three conversations with three different customers in regards to three different customer requests is demanding on the associate and may make it difficult for the associate to respond to customer requests within the standard two-minute time frame, particularly if one (or more) of the customers requires extended attention to process and/or execute the customer request. Therefore, a need indeed exists for the response time tracking tool of the present invention. The associate greatly benefits from the tool in regards to response time management and enables the associate to deliver a customer service experience of higher quality than without the tool.

The response time tracking tool preferably embodies a user-friendly, software-based graphic application. The response time tracking tool is configured to interface or integrate with a variety of existing digital platforms, including the chat analyzer system, as well as other systems associated with the entity or a third party. The response time tracking tool typically interfaces with a chat environment utilized by the associate when communicating with customers in regards to customer requests. The response time tracking tool may be integrated with a mobile application, an operating system, a website, or another computing device system. The response time tracking tool is configured to run or operate substantially simultaneously to other running applications. For example, the associate may utilize the response time tracking tool while running a chat application.

The response time tracking tool is configured to present itself as an independent window on a graphical interface (e.g., a display or screen associated with a device). The window of the response time tracking tool is preferably configured to remain on top of all other windows associated with running applications or operating systems. For example, when the associate is chatting with customers via a chat application window, the response time tracking tool window is on top of (e.g., in front of) the chat application window. Alternatively, the response time tracking tool window may be placed below (e.g., behind) any other windows associated with other applications. The response time tracking tool window is configured to be minimized, closed, maximized, expanded, shrunk, or modified in another manner.

Further, the window of the response time tracking tool may be moved around by the associate (or another user) independently, or independent of any co-running applications or windows associated with other applications. The response time tracking tool window may be docked or locked to a particular location on a screen, which may be predetermined by an administrator or customized by the associate. The response time tracking tool window may be visible by the associate on the screen at all times during its operation.

The response time tracking tool typically provides one independent window for each open chat conversation. For example, if the associate is tasked with responding to two different customer requests and therefore has two open chat windows, two response time tracking tool windows are open, wherein each is associated with one of the open chat windows. Alternatively, the response time tracking tool may include only one window for multiple open chat windows.

The response time tracking tool window is configured to display various pieces of information to the associate during operation. A clock is prominently featured in the response time tracking tool window. The clock typically displays a time in a digital fashion, but may also include an option to display the time in an analog fashion. The response time tracking tool may interface with a system clock associated with a computing device (e.g., the device on which the response time tracking tool is running) For example, the response time tracking tool window may display a time that mirrors or substantially matches the system clock of the device. Alternatively, the response time tracking tool may communicate with a system clock associated with the entity, another application, an operating system, or the like. In some embodiments, the clock of the response time tracking tool is associated and synced with a world clock. The purpose of displaying the clock in the response time tracking tool window is to communicate to the associate the current time during chat conversations.

The response time tracking tool window may further provide the associate (or another user) with an option to convert the clock into a timer. The associate may toggle between the clock and the timer. The timer may be started, stopped, paused, resumed, or reset by the associate during operation. The purpose of the timer is to help the associate keep track of the amount of time that has elapsed since receiving a customer response. The timer may be configured to start or reset automatically at the instant a customer response (e.g., a chat message) is received. Alternatively, the associate may be required to click or select a “Start” button that begins the timer. The timer typically measures time associated with a delay in responding to each customer response.

Once the timer begins to run, the response time tracking tool is configured to alert the associate of passing of predetermined time intervals. Typically, the response time tracking tool alerts the associate at thirty-second intervals after receiving a customer response. In some embodiments, the response time tracking tool alerts the associate at various time intervals. For example, the response time tracking tool alerts the associate after sixty seconds have passed since receiving a customer response, and then continues to alert the associate every thirty seconds after the initial alert. In other embodiments, the response time tracking tool is configured to alert the associate at different time intervals configured by the associate, an administrator, or another user.

At each predetermined interval (e.g., after every thirty seconds), the response time tracking tool changes a color associated with the background of the response time tracking tool window. Changing of the background color is particularly useful for visually signaling to the associate the passing of each predetermined time interval and can signal that a particular chat conversation requires immediate attention and therefore helps the associate respond to customer responses within the require two-minute period of time.

The response time tracking tool window background color typically changes between three colors—blue, orange, and red—but may also incorporate other color options as well. Similar to a standard traffic light (green, yellow, and red), each color of the response time tracking tool window corresponds to a level of urgency or importance. For example, a blue response time tracking tool window background color may signal to the associate that there is, relatively speaking, no urgency in responding to a received customer request. Alternatively, an orange response time tracking tool window background color may signal to the associate that there is moderate urgency in responding to a received customer request. A red response time tracking tool window background color may signal to the associate that there is high urgency in responding to a received customer request. Each background window color is associated with a remaining amount of time that the associate has to respond to a customer response to avoid exceeding the two-minute response time delay limit.

The response time tracking tool is further configured to activate a buzzer that buzzes at predetermined time intervals. Buzzing may occur at the same predetermined time interval associated with the changing of the response time tracking tool window background color, or at another time interval. Typically, the buzzer activates at ninety-second intervals (e.g., ninety seconds after a customer response is received). The buzzer signals to the associate that urgency is now high in regards to responding to a customer response. The buzzer includes a mute and unmute function which is selectable by the user on the response time tracking tool window. Typically the buzzer is configured to activate at the end of each predetermined time interval in which the response time tracking tool window background color is orange.

The response time tracking tool is further configured to track various data points. For example, the response time tracking tool tracks a time delay between receiving each customer response and each associate-provide response to the customer response. In this regard, the response time tracking tool is enabled to determine the response time between each response in the chat conversation. Furthermore, the response time tracking tool is configured to calculate an average response time for the associate (e.g., how long on average it takes for the associate to respond to a customer response). The response time tracking tool is also configured to track in real time a total number of login hours (e.g., a number of hours that the associate is logged into a customer chat conversation application). The associate may initiate the tracking of total login hours by clicking or selecting the timer option, or by executing another action. In some embodiments, the device associated with the associate may be configured to detect an action provided by or associated with the associate to thus determine that the associate is indeed logged into the customer chat conversation application. In this regard, the associate may not be required to input or select the timer option in order to receive credit for being logged in and working in the customer chat conversation application.

The response time tracking tool is further configured to generate a report based on the tracked data points. The response time tracking tool may store the tracked data points, or transmit the report of the tracked data points to the associate, an administrator, or another user for review.

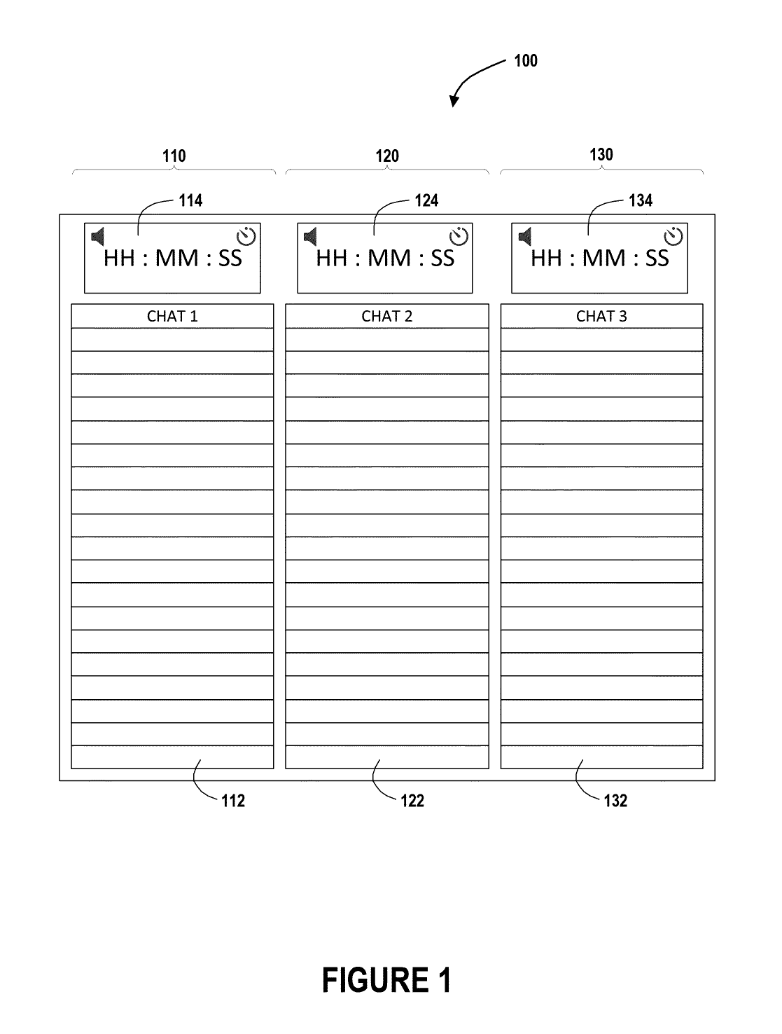

Referring now to the Figures, FIG. 1 illustrates an exemplary user interface 100 viewed and used by the associate when responding to customer requests and/or responses. The associate is typically responsible for responding to up to three different customer chats simultaneously. Therefore, the interface 100 is configured to include up to three different chat windows 110, 120, 130 with three different customers. Each chat window 110, 120, 130 includes a chat conversation 112, 122, 132, which is typically a textual dialogue held between the associate and the customer (or up to three customers as illustrated in FIG. 1). Each chat window further 110, 120, 130 includes a response time tracking tool 114, 124, and 134 that respectively corresponds to the chat windows 110, 120, 130. As stated above, the response time tracking tools 114, 124, 134 enable the associate using the customer chat conversation interface 100 to visibly and audibly be alerted of the current response time delays and therefore if an urgent response to a customer is required.

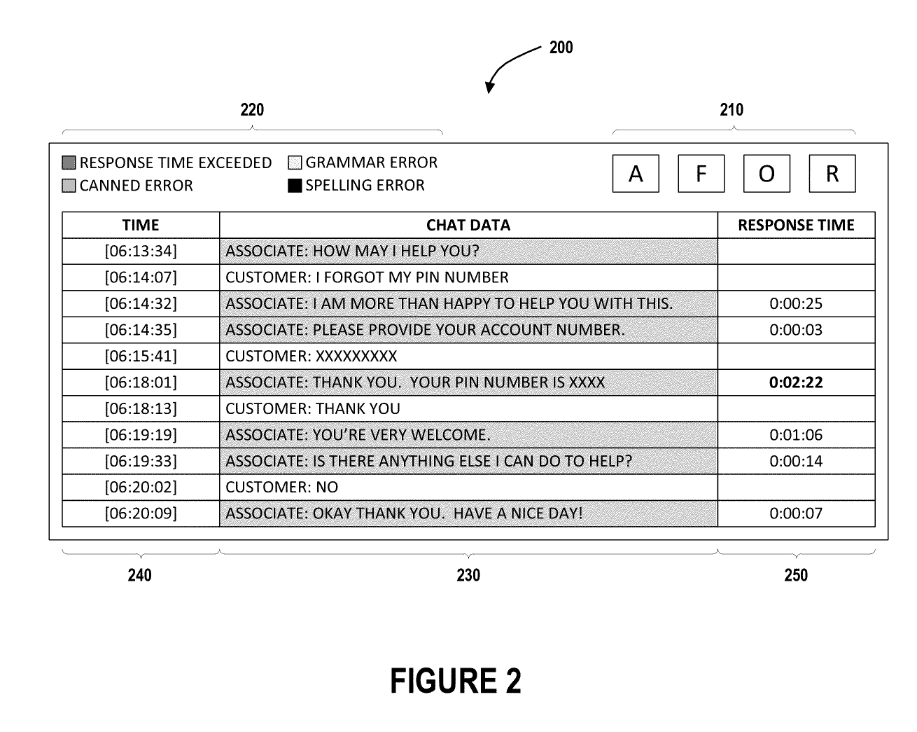

FIG. 2 illustrates an exemplary user interface 200 viewed and used by the user (e.g., an administrator) to analyze an associate's chat conversation transcript. The interface 200 includes a menu 210 which enables the user to select and execute various functions, including an “Analyze” function associated with the “A” block that initiates analysis of the chat conversation transcript. Also included in the interface 200 is a key 220 that informs the user of which colors correspond to which identified errors upon analysis of the chat conversation transcript. The interface 200 further includes chat data 230 which is typically an imported chat conversation transcript associated with a chat conversation 112, 122, 132 of FIG. 1. As displayed in FIG. 2, the system of the present invention analyzes the chat data 230 line by line and determines a timestamp 240 associated with each line of the chat data 230 (e.g., the chat conversation transcript). The system of the present invention further calculates and displays a response time 250 associated with each line of the chat data 230. The response time corresponds to the amount of time delay between a line of the chat data 230 received from the customer and a line of chat data 230 provided by the associate. The system of the present invention further is configured to identify any errors in the chat data 230, determine if a response time 250 exceeds two minutes or five minutes (or another predetermined period of time), and determine if any lines of the chat data 230 provided by the associate are canned responses. Canned responses are typically colored gray in the chat data 230 section as shown in FIG. 2.

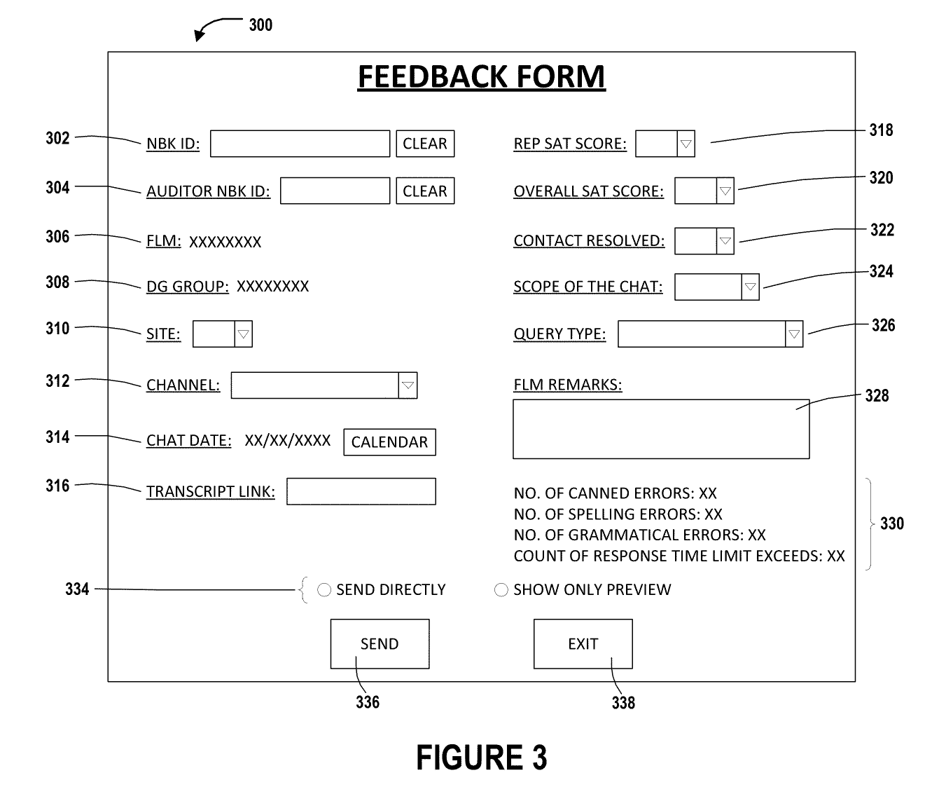

FIG. 3 illustrates an exemplary user interface 300 that enables the user (e.g., administrator) to provide feedback to the associate based on the analysis of the chat data 230 of FIG. 2. The user interface (or feedback form) 300 enables the user to input information associated with the analysis of the chat data 230, the associate, preferences, or the like. The user is enabled to input an ID associated with the associate 302, an ID associated with the auditor (e.g., the administrator), 304, a manager name 306, a group name 308, a site or location 310, a channel type 312, a date associated with the analyzed chat conversation 314, a transcript link or transcript ID 316, a satisfaction score associated with the associate 318, an overall satisfaction score 320, whether or not the customer's request was resolved 322, a chat scope 324, a query type associated with the customer request 326, comments or remarks 328, or other like information associated with the analysis of the chat data 230. The feedback form 300 further includes a summary of the number of detected occurrences of each error type 330. The user can, via the feedback form 300, choose to send the feedback directly to the associate or to only show a preview of a generated message based on the inputted feedback via a selection menu 334. The “Send” 336 button enables the user to send the feedback to the associate and initiates the generation of a message and/or report that includes the inputted feedback based on the chat data 230 analysis. The user may also exit the feedback form via the “Exit” 338 button.

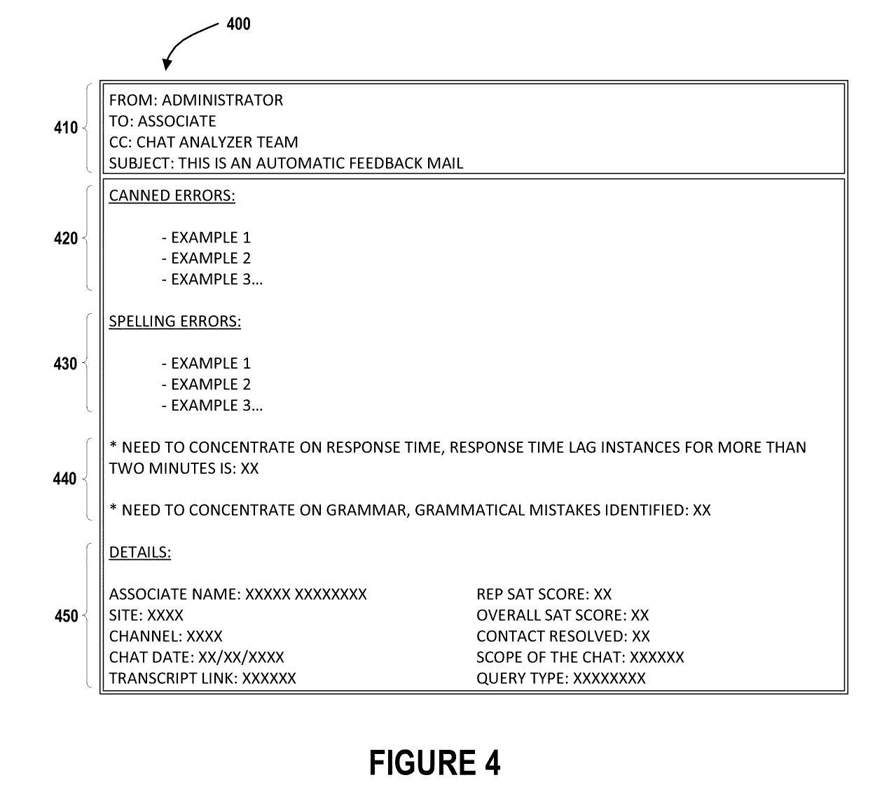

FIG. 4 illustrates an exemplary message 400 that is generated by the system of the present invention based on inputted feedback and analysis of the chat data 230. The message 400 includes a header 410 that shows the message is automatically generated by the system and no response to the message 400 by the associate may be necessary. The message 400 also includes information, such as examples of identified errors, associated with each identified error and error type, including canned errors 420 and spelling errors 430. The message 400 further includes system-generated recommendations 440 to the associate on how the associate may improve in future chat conversations. The message 400 further includes details 450 that outline the inputted feedback via the feedback form 300 of FIG. 3. The system then transmits the message 400 to the associate for review.

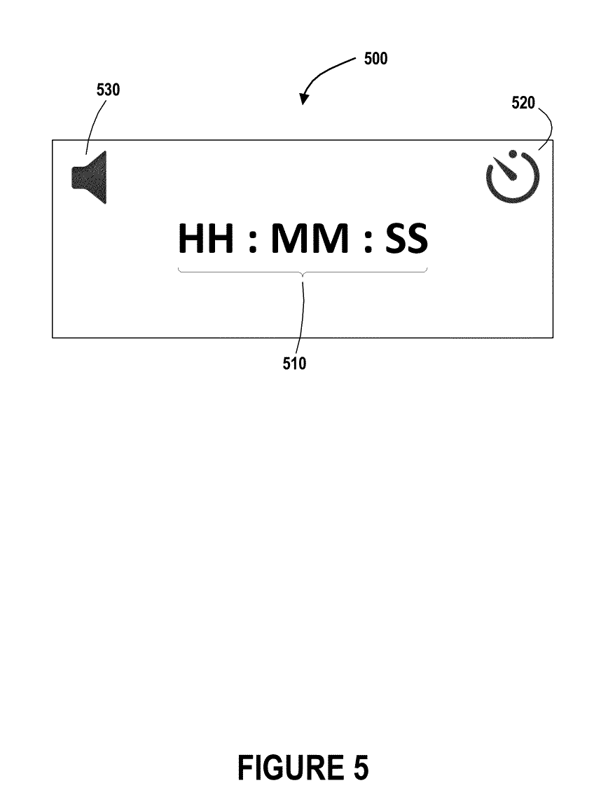

FIG. 5 illustrates an exemplary response time tracking tool window 500 that enables the associate to appropriately manage her or his response time to customer chat conversations. The response time tracking tool window 500 typically displays the current time (or a timer) 510 in a HH:MM:SS format. Selection of the timer 520 icon initiates presentation of a selection menu to the associate. The menu typically includes options that enable the user to toggle between a system clock and a timer display, mute the buzzer associated with the response time tracking tool, pause the timer, or exit from the response time tracking tool. The speaker 530 icon enables the associate to toggle between muting and unmuting the buzzer associated with the response time tracking tool.

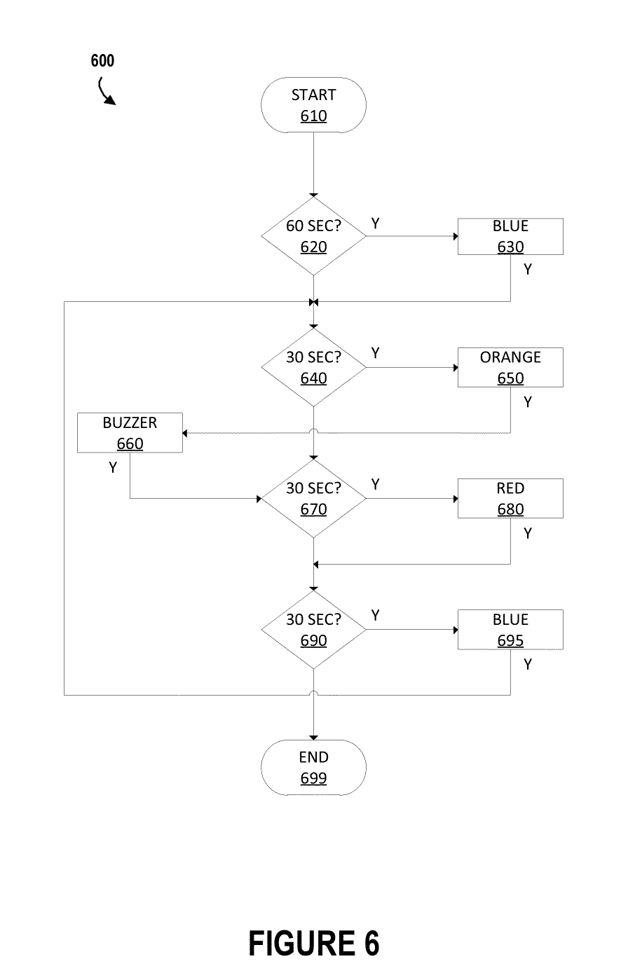

FIG. 6 illustrates an exemplary functional flow map 600 of the response time tracking tool. At block 610 the response time tracking tool is started. The associate may select to open the response time tracking tool application, window, or the like, or the response time tracking tool window may open automatically and substantially simultaneously to opening an application associated with conducting chat conversations with customers. The associate then begins to receive chat conversations from customers, and the response time tracking tool begins to track the time delay after each received customer response. At block 620, the response time tracking tool is configured to measure the first sixty seconds of associate response delay. During the first sixty seconds of delay 620, the response time tracking tool window is configured to display a blue background 630, indicating to the associate a low urgency in regards to responding to a customer response. After sixty seconds 620 have passed, the response time tracking tool is configured to measure the next thirty seconds 640 of associate delay. During the next thirty seconds 640, the response time tracking tool window is configured to display an orange background 650, indicating to the associate a moderate urgency in regards to responding to a customer response. After thirty seconds 640 have passed, the response time tracking tool is configured to activate the buzzer 660. The buzzer 660 provides an auditory alert and indicates to the associate that urgency in regards to responding to a customer response is elevated. At block 670, the response time tracking system is configured to measure the next thirty seconds of associate delay. During the next thirty seconds 670, the response time tracking system window is configured to display a red background 680, indicating to the associate a high urgency in regards to responding to a customer response. After thirty seconds 670 have passed, the response time tracking tool is configured to measure the next thirty seconds 690 of associate delay. During the next thirty seconds 690, the response time tracking tool window is configured to display a blue background 695 again, indicating to the associate a moderate urgency in regards to responding to a customer response. This essentially begins a second loop of the two-minute cycle associated with the changing of the response time tracking tool background color. At each determination of delay time 620, 640, 670, 690 the response time tracking tool is configured to detect if a response has been provided by the associate. Upon determination of a response provided by the associate, the map 600 directs the response time tracking tool to the end 699 of the cycle. The response time tracking tool typically resets the timer and begins the cycle again upon receipt of another customer response.

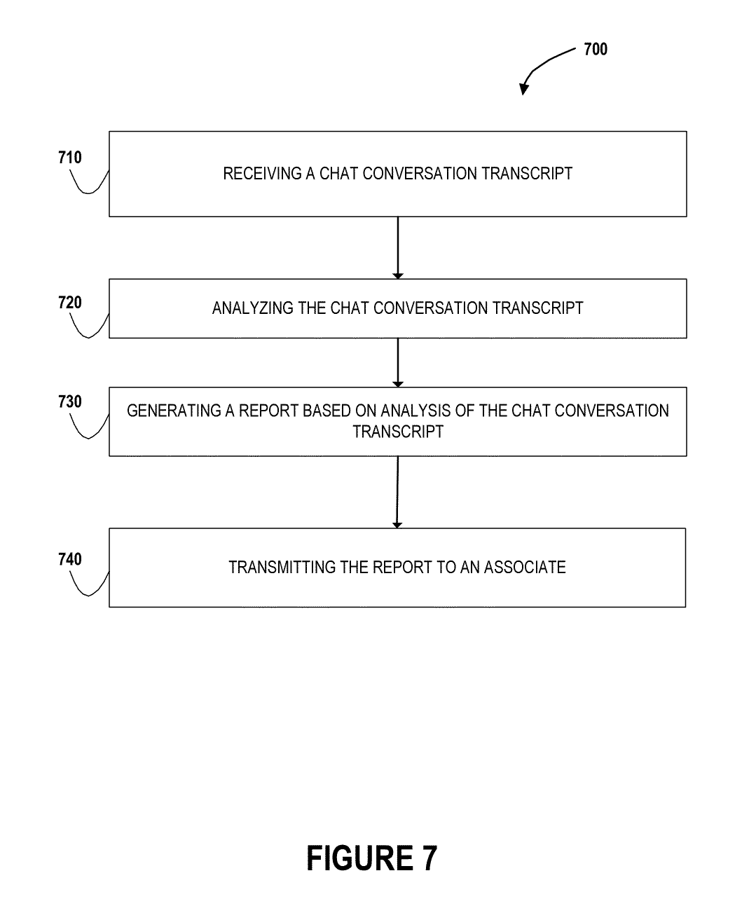

FIG. 7 is an exemplary process flow 700 for tracking associate response time in a chat conversation between an associate and a customer. At block 710, the process includes receiving a chat conversation transcript. At block 720, the process includes analyzing the chat conversation transcript. At block 730, the process includes generating a report based on analysis of the chat conversation transcript. At block 740, the process includes transmitting the report to an associate.

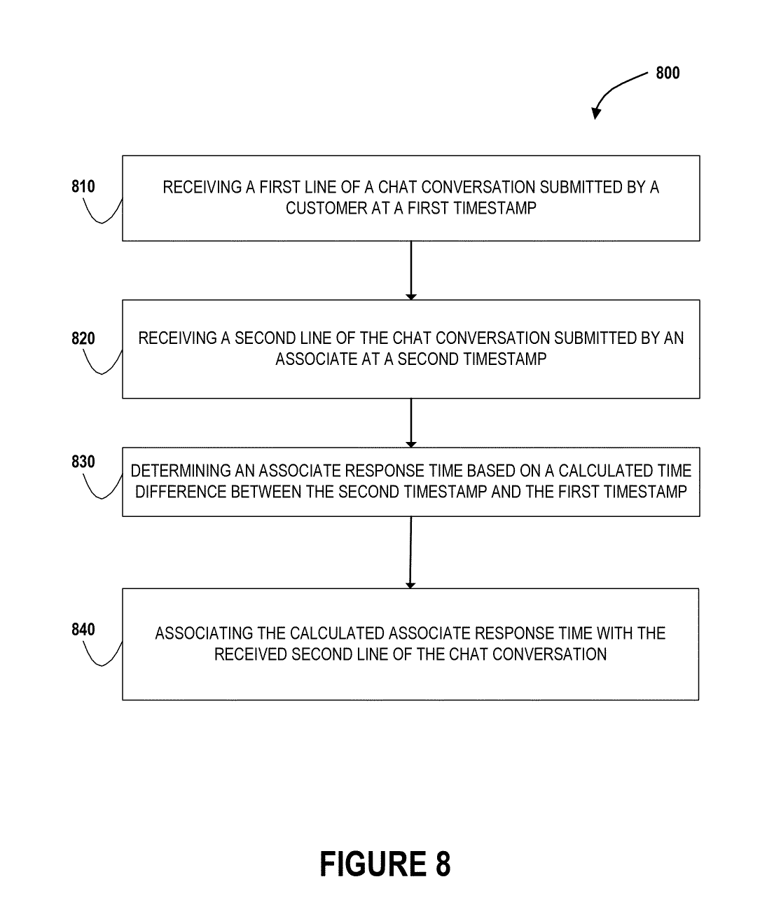

FIG. 8 is an exemplary process flow 800 for analyzing a chat conversation between an associate and a customer. At block 810, the process includes receiving a first line of a chat conversation submitted by a customer at a first timestamp. At block 820, the process includes receiving a second line of the chat conversation submitted by an associate at a second timestamp. At block 830, the process includes determining an associate response time based on a calculated time difference between the second timestamp and the first timestamp. At block 840, the process includes associating the calculated associate response time with the received second line of the chat conversation.

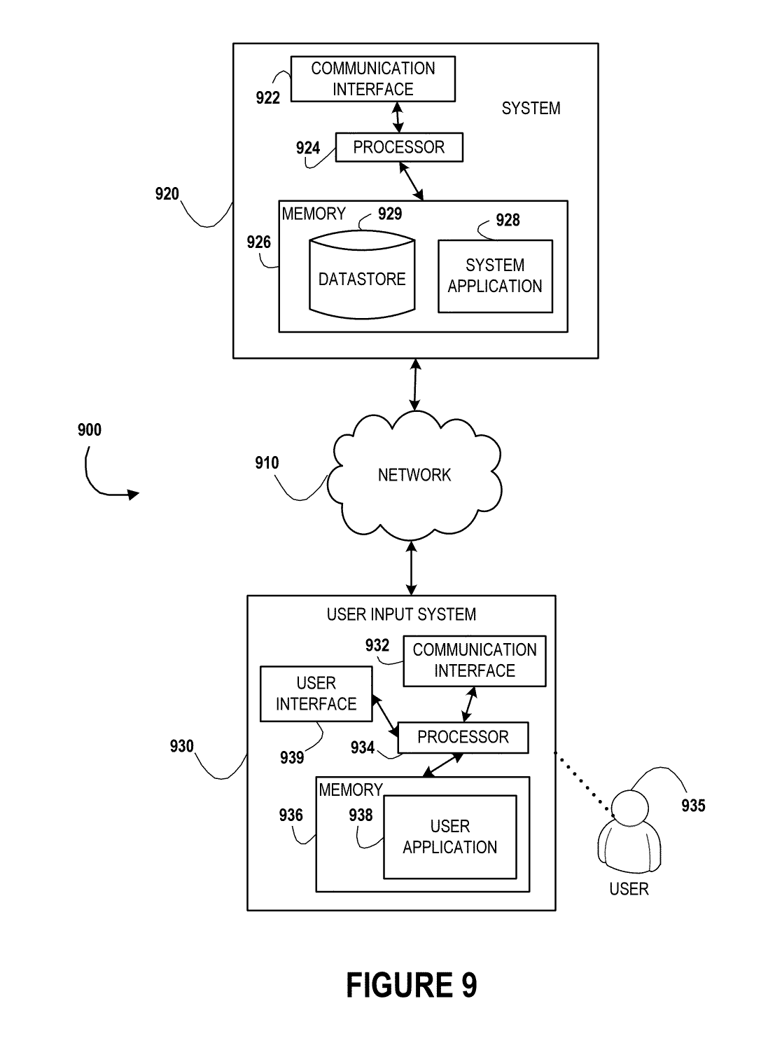

FIG. 9 is an exemplary block diagram illustrating technical components of a system 900 for implementing the chat analyzer system and the response time tracking tool as described in the process flows 600, 700, 800 described in FIGS. 6-8, as well as the exemplary interfaces 100, 200, 300, 400, 500, as illustrated in FIGS. 1-5. As illustrated, the system environment 900 includes a network 910, a system 920, and a user input system 930.

As shown in FIG. 9, the system 920, and the user input system 930 are each operatively and selectively connected to the network 910, which may include one or more separate networks. In addition, the network 910 may include a telecommunication network, local area network (LAN), a wide area network (WAN), and/or a global area network (GAN), such as the Internet. It will also be understood that the network 910 is secure and may also include wireless and/or wireline and/or optical interconnection technology.

FIG. 9 also illustrates a system 920, in accordance with an embodiment of the present invention. The system 920 may refer to the “apparatus” described herein. The system 920 may include any computerized apparatus that can be configured to perform any one or more of the functions of the system 920 described and/or contemplated herein. In accordance with some embodiments, for example, the system 920 may include a computer network, an engine, a platform, a server, a database system, a front end system, a back end system, a personal computer system, and/or the like. Therefore, the system 920 may be a server managed by the entity. The system 920 may be located at the facility associated with the entity or remotely from the facility associated with the entity. In some embodiments, such as the one illustrated in FIG. 9, the system 920 includes a communication interface 922, a processor 924, and a memory 926, which includes a system application 928 and a datastore 929 stored therein. As shown, the communication interface 922 is operatively and selectively connected to the processor 924, which is operatively and selectively connected to the memory 926.

It will be understood that the system application 928 may be configured to implement any one or more portions of the various user interfaces and/or process flow described herein. The system application 928 may interact with the user application 938. It will also be understood that, in some embodiments, the memory includes other applications. It will also be understood that, in some embodiments, the system application 928 is configured to communicate with the datastore 929, the user input system 930, or the like.

It will be further understood that, in some embodiments, the system application 928 includes computer-executable program code portions for instructing the processor 924 to perform any one or more of the functions of the system application 928 described and/or contemplated herein. In some embodiments, the system application 928 may include and/or use one or more network and/or system communication protocols.

In addition to the system application 928, the memory 926 also includes the datastore 929. As used herein, the datastore 929 may be one or more distinct and/or remote datastores. In some embodiments, the datastore 929 is not located within the system and is instead located remotely from the system. In some embodiments, the datastore 929 stores information or data described herein.

It will be understood that the datastore 929 may include any one or more storage devices, including, but not limited to, datastores, databases, and/or any of the other storage devices typically associated with a computer system. It will also be understood that the datastore 929 may store information in any known way, such as, for example, by using one or more computer codes and/or languages, alphanumeric character strings, data sets, figures, tables, charts, links, documents, and/or the like. Further, in some embodiments, the datastore 929 may include information associated with one or more applications, such as, for example, the system application 928. It will also be understood that, in some embodiments, the datastore 929 provides a substantially real-time representation of the information stored therein, so that, for example, when the processor 924 accesses the datastore 929, the information stored therein is current or substantially current.

It will be understood that the embodiment of the system environment illustrated in FIG. 9 is exemplary and that other embodiments may vary. As another example, in some embodiments, the system 920 includes more, less, or different components. As another example, in some embodiments, some or all of the portions of the system environment 900 may be combined into a single portion. Likewise, in some embodiments, some or all of the portions of the system 920 may be separated into two or more distinct portions.

In addition, the various portions of the system environment 900 may be maintained for and/or by the same or separate parties. It will also be understood that the system 920 may include and/or implement any embodiment of the present invention described and/or contemplated herein. For example, in some embodiments, the system 920 is configured to implement any one or more of the embodiments of the process flows described and/or contemplated herein in connection any process flow described herein. Additionally, the system 920 or the user input system 930 is configured to initiate presentation of any of the user interfaces described herein.

The user input system 930 may include any computerized apparatus that can be configured to perform any one or more of the functions of the user input system 930 described and/or contemplated herein. For example, the user 935 may use the user input system 930 to transmit and/or receive information or commands to and from the system 920. In some embodiments, for example, the user input system 930 may include a personal computer system (e.g. a non-mobile or non-portable computing system, or the like), a mobile computing device, a personal digital assistant, a mobile phone, a tablet computing device, a network device, a wearable computing device, a sensor, and/or the like. As illustrated in FIG. 9, in accordance with some embodiments of the present invention, the user input system 930 includes a communication interface 932, a processor 934, a memory 936 having a user application 938 stored therein, and a user interface 939. In such embodiments, the communication interface 932 is operatively and selectively connected to the processor 934, which is operatively and selectively connected to the user interface 939 and the memory 936. In some embodiments, the user 935 may use the user application 938 to execute processes described with respect to the process flow and interfaces described herein. Specifically, the user application 938 executes the process flow described in FIGS. 6-8.

Each communication interface described herein, including the communication interface 932, generally includes hardware, and, in some instances, software, that enables the user input system 930, to transport, send, receive, and/or otherwise communicate information to and/or from the communication interface of one or more other systems on the network 910. For example, the communication interface 932 of the user input system 930 may include a wireless transceiver, modem, server, electrical connection, and/or other electronic device that operatively connects the user input system 930 to another system such as the system 920. The wireless transceiver may include a radio circuit to enable wireless transmission and reception of information. Each processor described herein, including the processor 934, generally includes circuitry for implementing the audio, visual, and/or logic functions of the user input system 930. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 938 of the memory 936 of the user input system 930.

Each memory device described herein, including the memory 936 for storing the user application 938 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 9, the memory 936 includes the user application 938. In some embodiments, the user application 938 includes an interface for communicating with, navigating, controlling, configuring, and/or using the user input system 930. In some embodiments, the user application 938 includes computer-executable program code portions for instructing the processor 934 to perform one or more of the functions of the user application 938 described and/or contemplated herein. In some embodiments, the user application 938 may include and/or use one or more network and/or system communication protocols.

Also shown in FIG. 9 is the user interface 939. In some embodiments, the user interface 939 includes one or more output devices, such as a display and/or speaker, for presenting information to the user 935. In some embodiments, the user interface 939 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 935. In some embodiments, the user interface 939 includes the input and display devices of a mobile device, which are operable to receive and display information.

Also shown in FIG. 9 is a user 935 of the user input system 930. The user input system 930 may be any computing device. The user 935 may be a person who uses the user input system 930 to execute a user application 938. The user application 938 may be an application to communicate with the system 920, perform a transaction, input information onto a user interface presented on the user input system 930, receive and/or transmit information, the like. The user application 938 and/or the system application 928 may incorporate one or more parts of any process flow described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for tracking associate response time in a chat conversation between an associate and a customer, the apparatus comprising:
a memory;
a processor; and
a module stored in memory, executable by a processor, and configured to:
receive a first line of the chat conversation submitted by the customer at a first timestamp;
receive a second line of the chat conversation submitted by the associate at a second timestamp;
determine an associate response time based on a calculated time difference between the second timestamp and the first timestamp; and
associate the calculated associate response time with the received second line of the chat conversation.

2. The system of claim 1, wherein receiving the first line of the chat conversation initiates counting of a timer substantially simultaneous to the first timestamp.

3. The system of claim 2, wherein the timer comprises a suite of functions that enables the associate to at least one of start, stop, pause, reset, or exit the timer.

4. The system of claim 2, wherein the timer comprises a clock function.

5. The system of claim 4, wherein the clock function is configured to sync with a system clock associated with a device associated with the associate and used to run a customer chat conversation application.

6. The system of claim 5, wherein the customer chat conversation application enables the associate to hold at least one and up to three simultaneous customer chat conversations with customers.

7. The system of claim 2, wherein the timer is configured to be displayed via an interface in a window.

8. The system of claim 7, wherein the window associated with the timer includes a background color, wherein the background color is configured to change at predetermined time intervals.

9. The system of claim 7, wherein the timer is configured to activate an audible buzzer at predetermined time intervals.

10. The system of claim 9, wherein the buzzer comprises mute and unmute functions.

11. The system of claim 7, wherein the window associated with the timer is positioned on top of all other open windows so that the window associated with the timer is always visible by the associate via the interface, wherein the window associated with the timer is configured to be moved on the interface independent of all other open applications.

12. The system of claim 2, wherein receiving the second line of the chat conversation initiates stoppage of counting by the timer substantially simultaneously to the second time stamp.

13. The system of claim 1, wherein determining the associate response time comprises:
comparing the associate response time to a predetermined time limit;
determining that the associate response time is equal to or exceeds the predetermined time limit.

14. The system of claim 2, wherein determining the associate response time comprises calculating an average associate response time for at least one of the chat conversation held between the associate and the customer as a whole or all chat conversations held between the associate and a plurality of customers.

15. The system of claim 5, wherein determining the associate response time comprises calculating a total amount of time associated with how long the associate has been logged in to the customer chat conversation application.

16. The system of claim 12, wherein the timer is configured to reset substantially simultaneously to the second time stamp.

17. The system of claim 14, wherein associating the calculated associate response time with the received second line of the chat conversation comprises associating the calculated average response time with the associate.

18. The system of claim 1, wherein associating the calculated associate response time with the received second line of the chat conversation comprises generating a report that includes at least the calculated associate response time and transmitting the report to at least one of the associate, an administrator, a team manager, a team leader, a supervisor, or a customer service specialist.

19. A method for tracking associate response time in a chat conversation between an associate and a customer, the method comprising:
receiving, using a computing device processor, a first line of the chat conversation submitted by the customer at a first timestamp;
receiving, using a computing device processor, a second line of the chat conversation submitted by the associate at a second timestamp;
determining, using a computing device processor, an associate response time based on a calculated time difference between the second timestamp and the first timestamp; and
associating, using a computing device processor, the calculated associate response time with the received second line of the chat conversation.

20. A computer program product for tracking associate response time in a chat conversation between an associate and a customer, the computer program product comprising a non-transitory computer-readable medium comprising code causing an apparatus to:
receive a first line of the chat conversation submitted by the customer at a first timestamp;
receive a second line of the chat conversation submitted by the associate at a second timestamp;
determine an associate response time based on a calculated time difference between the second timestamp and the first timestamp; and
associate the calculated associate response time with the received second line of the chat conversation.
